(19) United States
(12) Patent Application Publication
(10) Pub. No.: US 2024/0403486 A1
(43) Pub. Date: Dec. 5, 2024

(54) MANAGING AND ROUTING OF ENDPOINT TELEMETRY USING REALMS

(71) Applicant: Proofpoint, Inc., Sunnyvale, CA (US)

(72) Inventors: Alexander Kremer, Lexington, MA (US); Khurram Ghafoor, Lexington, MA (US); Marc Steven Burt, Waltham, MA (US)

(21) Appl. No.: 18/800,452

(22) Filed: Aug. 12, 2024

Related U.S. Application Data
(62) Division of application No. 17/760,527, filed on Mar. 15, 2022.
(60) Provisional application No. 62/903,828, filed on Sep. 21, 2019.

(51) Int. Cl. G06F 21/62; G06F 21/55; H04L 9/40

(52) U.S. Cl. CPC G06F 21/6254; G06F 21/554; H04L 63/0245

(57) ABSTRACT

A computer network includes user endpoint devices geographically distributed relative to one another such that at least one of the endpoint devices is subject to a different set of data protection or privacy restrictions than other endpoint devices and data processing facilities coupled to the user endpoint devices over a network. The data processing facilities are in different geographical regions or sovereignties. A computer-based endpoint agent is in each of the endpoint devices. Each endpoint agent is configured to collect telemetry data relating to user activity at its associated endpoint device and transmit the collected telemetry data to a selected one of the data processing facilities, according to an applicable realm definition, in compliance with the data protection or privacy restrictions that apply to the agent's endpoint device.

### CROSS-REFERENCE TO RELATED APPLICATION(S)

This application is a divisional of U.S. patent application Ser. No. 17/760,527, filed Mar. 15, 2022, and entitled MANAGING AND ROUTING OF ENDPOINT TELEMETRY USING REALMS, which is a national stage entry of PCT Application No. PCT/US20/51739, filed Sep. 21, 2020 and entitled MANAGING AND ROUTING OF ENDPOINT TELEMETRY USING REALMS, which claims the benefit of priority to U.S. Provisional Patent Application No. 62/903,828, entitled REALMS—MECHANISM FOR MANAGEMENT AND ROUTING OF ENDPOINT TELEMETRY AS A METHOD FOR DATA SOVEREIGNTY PROTECTION, which was filed on Sep. 21, 2019. The disclosures of the prior applications are incorporated by reference herein in its entirety.

### FIELD OF THE INVENTION

This disclosure relates to managing and routing endpoint telemetry and, more particularly, relates to managing and routing endpoint telemetry using realms.

### BACKGROUND

Data protection, data privacy, and data sovereignty are of paramount importance in today's connected society. Various legal regimes, such as the General Data Protection Regulation (“GDPR”) in the European Union and the European Economic Area, and the California Consumer Privacy Act (CCPA) in California, have been enacted to help enhance data privacy and protection in different sovereignties. These legal regimes impose obligations on companies that collect, store and process data in the various sovereignties and the obligations may differ from one sovereignty to the next. At the same time, society, including businesses as well as their customers and clients are becoming more sophisticated and concerned about data protection, data privacy, and data sovereignty every day

A need exists to facilitate compliance with various data protection and privacy concerns and expectations.

### SUMMARY OF THE INVENTION

This application relates to segmenting of data in a computer network into realms for data collection, storage and processing policy, and routing telemetry data from endpoint devices in those realms for remote storage and processing according to different sets of data protection and privacy restrictions that apply to each realm. Moreover, gathering sensitive information in the form of endpoint activity telemetry, which may be subject to a special set of restrictions required by local privacy laws and regulations, such as the General Data Protection Regulation (“GDPR”) in the European Union (EU) or the California Consumer Privacy Act (“CCPA”), is simplified. The systems and techniques disclosed herein facilitate compliance with such data privacy regulations including, for example, the GDPR or the CCPA.

In one aspect, an organization includes user endpoint devices geographically distributed relative to one another such that at least one of the endpoint devices is subject to a different set of data protection or privacy restrictions than other endpoint devices and data processing facilities coupled to the user endpoint devices over a network. The data processing and storage facilities are in different geographical regions or sovereignties. An endpoint agent is in each of the endpoint devices. Each endpoint agent is configured to collect telemetry data relating to user activity at its associated endpoint device and transmit the collected telemetry data to a selected data storage and processing facility, according to an applicable realm definition, in compliance with the data protection or privacy restrictions that apply to the agent's endpoint device.

In yet another aspect, a method includes: creating a realm in a computer-based network, wherein the realm includes a realm definition with governing data collection policies, processing methods, processing facilities as permissible destinations under applicable data protection or privacy restrictions. As part of installing an endpoint agent in an endpoint device; realm references and credentials are provided and used by the endpoint agents to register in order to obtain configuration updates on an ongoing basis. As such, both agents and processing facilities are governed by realm definitions, for example, which data is collected as part of endpoint activity telemetry by the agent and what retention the data should have as it is stored in the data processing facility.

In some implementations, one or more of the following advantages are present.

In some implementations, the systems and techniques disclosed herein combines regional regulatory restrictions, encapsulated in the concept of realms, together with global endpoint management policies to provide a unique solution solving the problems of locality and data sovereignty. The systems disclosed herein typically gather large quantities of telemetry from endpoint agents, where data is gathered based on activity profile. By combining policy and realms into a set of data gathering, data restriction and telemetry routing rules, endpoint agents can be managed cohesively.

By using globally defined data collection policies and combining them into a realm configuration, data sovereignty and adherence to local regulations can be maintained, while at the same time enabling the collection of telemetry for security and audit purposes.

In certain implementations, an additional benefit of dynamic realm association with endpoint agent is that for global organizations having multiple offices across geographical regions, when the user is working in a particular region, the local policies can take effect, thus ensuring that the data is collected, transferred and stored according to the geographical policy applicable.

An additional benefit, in some instances, traffic may be directed to an in-region facility thus not compromising on network bandwidth and latency.

Other features and advantages will be apparent from the description and drawings, and from the claims.

### BRIEF DESCRIPTION OF THE DRAWINGS

FIG. 1 is a schematic representation of computer network segmented into realms.

FIG. 2 is a partial schematic representation of a telemetry gathering security system deployed in the computer network of FIG. 1.

FIG. 3 is a schematic representation showing how various sets of data gathering rules (policies) might be mapped to and apply to the endpoint devices in various realms.

FIG. 4 is a schematic representation showing an exemplary mapping of tenants segmented into realms with allowed regions for routing data from each of the tenants to allowed data processing facilities.

FIGS. 5A-5C are swim lane diagrams (or cross functional flow charts) that identify the roles of various system components, within an exemplary implementation of a computer network, to create and/or adjust a realm, install an endpoint agent, and register the endpoint agent with a realm.

FIG. 6 is a basic schematic representation of an exemplary endpoint device.

FIG. 7 shows an example of a screenshot that might give the administrator access to enter certain data into the security system.

Like reference characters refer to like elements.

### DETAILED DESCRIPTION

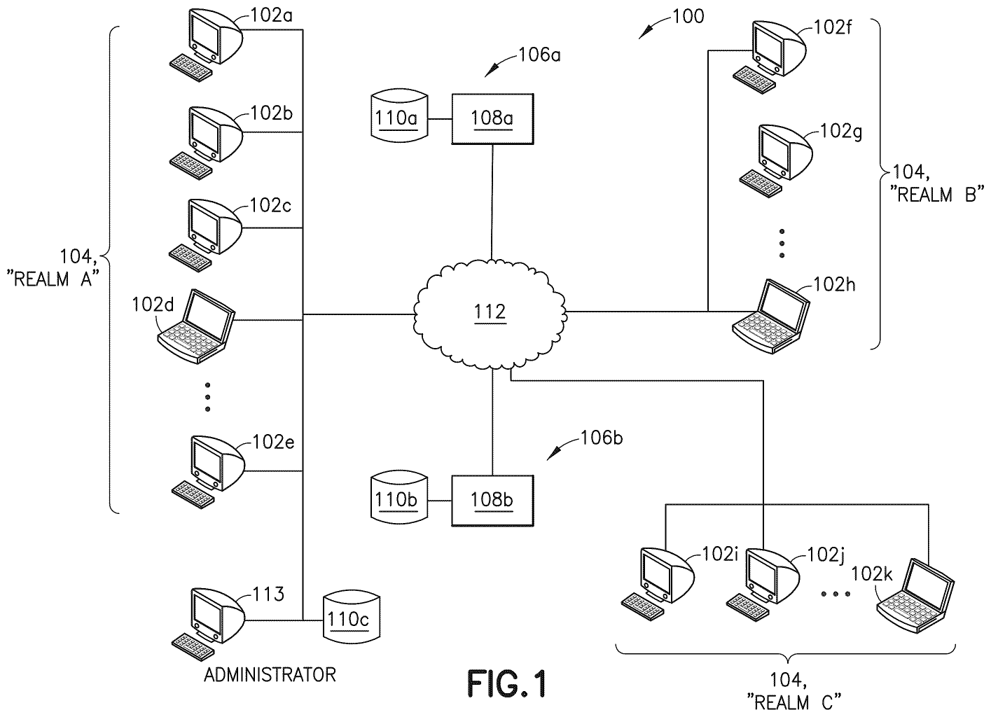

FIG. 1 is a schematic representation of a computer network 100 that has a plurality of endpoints or nodes, each of which has, connected to it, one or more associated endpoint devices 102a-102k. In a typical implementation, the endpoints and their associated devices 102a-102k may be globally distributed such that the activities conducted from one or more of the connected endpoint devices 102a-102k may be subject to data protection or data privacy restrictions that differ from the data protection or data privacy restrictions that apply to activities conducted from other endpoint devices 102a-102k. More specifically, in the illustrated example, the network 100 can be segmented into three separate groups (or “realms”) 104 of endpoint devices: 1) realm A, which includes endpoint devices 102a-102e, 2) realm B, which includes endpoint devices 102f-102h, and 3) realm C, which includes endpoint devices 102i-102k.

The endpoint devices in each realm 104 (A, B, C) may be subject to data protection and privacy restrictions that differ, in at least some respects, from the data protection and privacy that apply to the endpoint devices in other realms. One way this sort of situation might arise would be if the endpoint devices in each of the realms were physically located in a different geographic sovereignty or region than the end point devices in the other realms. Referring to the illustrated implementation, for example, the endpoint devices 102a-102e in realm A might be located in Ireland and, therefore, be subject to data protection and privacy restrictions consistent with the GDPR, while the endpoint devices 102f-102h in realm B might be physically located in California and, therefore, be subject to data protection and privacy restrictions consistent with the CCPA, and endpoint devices 102i-102k in realm C might be physically located in Italy and, therefore, also be subject to data protection and privacy restrictions consistent with the GDPR.

The computer network 100 has a plurality of remote processing systems 106a, 106b, each of which has a computer server 108a, 108b with one or more internal computer processors and computer memory 110a, 110b. Each endpoint devices 102a-102k and each remote processing systems 106a, 106b are connected, and able to communicate with the other connected network components, via a communications network 112.

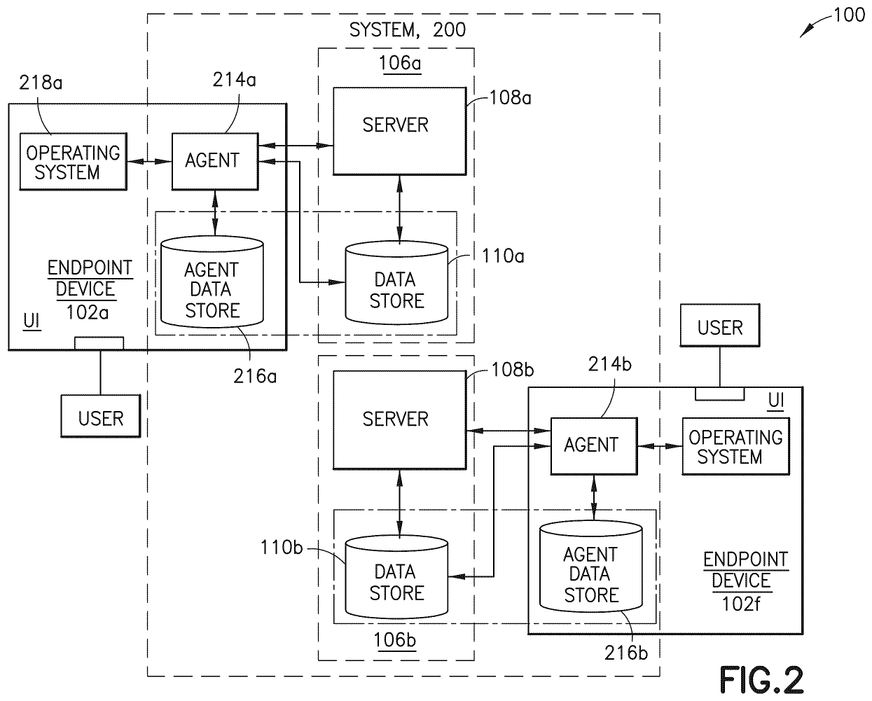

The computer network 100 has a network security system 200 with an insider threat management (ITM) component that monitors user activities at the user interfaces (UI) of various endpoint devices and analyzes those activities to identify any insider threats, including threats to data protection or privacy breaches, based on the monitored user activities at the endpoint devices 102a-102k across the network 100. FIG. 2 is a partial schematic representation showing one such example of this kind of network security system 200 deployed in computer network 100.

The illustrated security system 200 includes a computer-based agent 214a-214k, with an associated computer-based data store 216a-216k, deployed in each respective one of the endpoint devices 102a-102k. The illustrated security system 200 also has remote data processing and storage capabilities at each respective one of the remote processing systems 106a, 106b. More specifically, in this regard, each respective one of the remote processing systems 106a, 106b has a server 108a, 108b with a computer-based data store 110a, 110b.

In a typical implementation, each agent 214a-214k collects telemetry data that represents user activities on the user interface (UI) at its associated endpoint device 102a-102k, the system 200 analyzes the collected telemetry data to identify any potential threats represented, and alerts the security or compliance staff (e.g., a system administrator), for example, of any such identified threats. In response to such an alert, the security or compliance staff may take corrective or prophylactic measures to quash or minimize any such threats. Moreover, in some implementations, the system 100 may be configured to take certain corrective or preventative measures (e.g., preventing access) automatically (e.g., without direct, real time involvement from the security or compliance staff).

One example of a security system that collects telemetry data from endpoint devices for purposes of assessing threat risk is the ObserveIT Insider Threat Management (ITM) solution, available from Proofpoint. Inc.

As mentioned above, the telemetry data collected by the endpoint agents may be subject to handling and processing restrictions based on which realm its associated endpoint device 102a-102k belongs to. Typically, the realm 104 to which each respective endpoint device 102a-102k belongs determines where the telemetry data collected from that endpoint device can be sent-for processing and/or viewing and/or storing.

To keep track of which endpoint devices 102a-102k belong to which realms, a system, for example, may, in some implementations, store in the system's computer-based memory, a unique identifier for each specific one of the endpoint devices 102a-102k in logical association with a unique identifier for a corresponding one of the realms 104

In a typical implementation a set of policies (e.g. rules for data gathering) may be defined globally and applied in various combinations to realms. A simple combination may include a set of policies governing collection of security telemetry around execution of unauthorized software with a set of policies restricting telemetry collection required by local privacy laws and regulations.

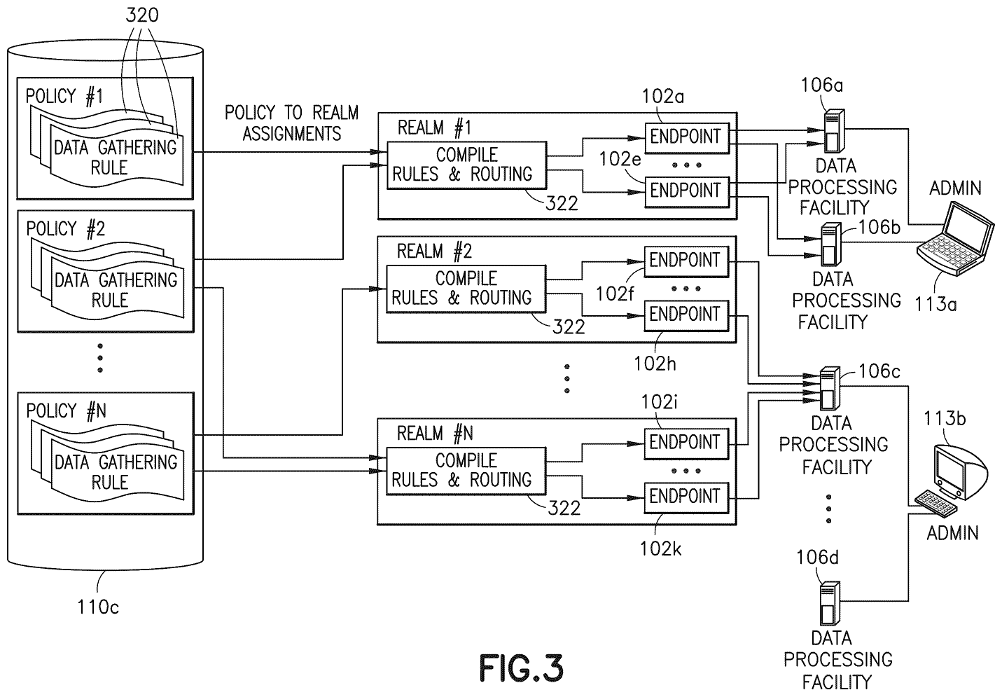

FIG. 3 is a schematic representation of how various sets of data gathering rules (policies) might be mapped to and apply to the endpoint devices 102a-102k of the various realms 104 (A, B, C). Examples of data gathering rules are:
If database client applications (listed explicitly by executable name) are executed on sensitive database servers (listed explicitly by hostname), then transmit telemetry of those activities including usernames, process information (e.g. SQL statements) as well as a screenshot of the activity.
If an execution of a file upload to a website not on the authorized list (listed explicitly by corporate domain names) is detected by any user in a user group with access to sensitive data (listed explicitly by OS group names), transmit telemetry of users activities immediately before and after the sensitive file upload (time span provided in seconds before and seconds after).

According to the illustrated implementation, a plurality of policies (#1, #2, . . . #N) are stored in an endpoint agent configuration system 110c (usually part of a data gathering service solution). Each policy has a plurality of data gathering rules 320. In some implementations, the data gathering rules 320 for one policy may overlap in some ways with the data gathering rules 320 for another policy. For example, it is possible that a particular one of the data gathering rules 320 may appear in more than one of the policies. That said, in a typical implementation, every policy is different, in at least some way, from all of the other policies.

In the illustrated example, policy #1 applies to the endpoints 102a-102e in realm A of network 100, policy #2 applies to the endpoints 102a-102e in realm A of network 100 and to the endpoints 102i-102k of realm C, policy #N applies to the endpoints 102f-102h of realm B and to the endpoints 102i-102k of realm C. In a typical implementation, as indicated at 322, the system 200 combines or compiles the data gathering rules (from the applicable policies), and the data routing rules (based on applicable realm) for each endpoint device 102a-102k. In a typical implementation, compiling includes creating a document or file that is suitable for consumption and use by the associated endpoint agent. In a typical implementation, this occurs in the system back end (e.g., 106a, 106b). The resulting document or file (with the combined and compiled rules information) may be stored in a data store (e.g., 110a) in the system backend and/or may be deployed (immediately or at a later time) to the associated agent data store (e.g., 216a) at any of the corresponding endpoint agents (e.g., 214a).

In a typical implementation, the data gathering rules data (from any applicable policies), and the data routing rules (based on the applicable realm) instruct each endpoint agent on the endpoint devices 102a-102k as to what sorts of telemetry data should be collected and transmitted by the endpoint agent and to what data processing facility or other destination the collected telemetry data can be or should be transmitted.

According to the illustrated implementation, the endpoint agents in endpoint devices 102a-102e of realm A are able to transmit collected telemetry data to data processing facility 106a or 106b, the endpoint agents in the endpoint devices 102f-102h of realm B are able to transmit collected telemetry data to data processing facility 106c, and the endpoint agents in the endpoint devices 102i-102k of realm C are able to transmit collected telemetry data to data processing facility 106c.

Where more than one option is available for transmitting collected telemetry data (e.g., the endpoint agent 214a in endpoint device 102a can transmit data to data processing facility 106a or to data processing facility 106b, the associated endpoint agent (e.g., 214a) may select either one of the available options based on any one or more of a variety of approaches. Such approaches may include, for example, alternating between or cycling through options, selecting based on a hierarchy, selecting based on load balancing considerations, selecting randomly and finally selecting it based on a clear rule part of realm policies. This enables data to be stored and processed in a facility best suited for the task for either operational or data sovereignty reasons.

According to the illustrated implementation, information (e.g., alerts, and underlying telemetry data about user activities related to the alerts, etc.) from data processing facility 106a and data processing facility 106b may be accessed and viewed from a first administrator's workstation 113a, but not from a second administrator's workstation 113b. Moreover, the same sort of information from data processing facility 106b may be accessed and viewed from the second administrator's workstation 113b, but not from the first administrator's workstation 113a. Similarly, the same sort of information from data processing facility 106d may be accessed and viewed from the second administrator's workstation 113b, but not from the first administrator's workstation 113a.

In this regard, telemetry data access, processing, storage and/or viewing privileges in network 100 may be restricted by the system 200, automatically, to only those devices (e.g., servers, memory, workstation, etc.) that are located within the same sovereignty (e.g., state, country, region, etc.) where the endpoint devices, from which the data originated are located. There are many ways in which these sorts of restrictions may be implemented. In one such example, any packets transmitted through the network 100 with the associated telemetry data may be tagged with an identifier that corresponds with its realm and/or applicable policies. At each node in the network, the system (e.g., a processor local to that node) determines, based on the tagged identifier, the applicable access, processing, storage and/or viewing privileges for that data and handles and/or retransmits the data accordingly.

In a typical embodiment, in setting up the system represented in FIG. 3, the system may store, in a computer-based memory device (e.g., 110c), an indication that policy #1 (identified by a unique identifier such as a pointer to a memory location) applies to realm A, policy #2 (identified by a unique identifier such as a pointer to a memory location) applies to realm B, and policy #3 (identified by a unique identifier such as a pointer to a memory location) applies to realm C. Each rule set may be stored at a memory location in the network 100 that corresponds to the memory location identified by its associated pointer.

Some of the applicable rule sets for handling of telemetry data collected at the endpoint devices of the various realms may require that any processing or viewing of data must occur, if at all, within a local jurisdiction (e.g., the same country or geographic region) where the data was collected. Some such regulations may include other requirements, too, relating, for example, to the omission or anonymization of certain personally identifiable information in the collected data. Other requirements or different requirements may be applicable, too. In some instances, the entity (e.g., company or organization) collecting and processing the data may have other requirements/preferences regarding, for example, how and where any collected data should be processed. Of course, any such requirements or preferences can evolve over time by virtue of changes in the applicable laws or changes in entity requirements/preferences.

The computer network 100 in FIG. 1, including the security system 200, is particularly well-suited for adapting dynamically to a changing landscape of applicable routing and processing requirements and/or preferences. In this regard, as the landscape of applicable rules and/or preferences changes, the system administrator can update (e.g., in memory 110c) any policies (rule sets), applicability of various policies to the realms, and/or associations between the realms and the various endpoint devices. These updates can be deployed across the system 100 in any number of potential manners.

For example, in some implementations, the endpoint agents 214a-214k in the various endpoint devices 102a-102k may be configured to send requests, periodically, for any available updates regarding the rules that are applicable to its associated endpoint device 102a-102k. As an example, endpoint agent 214a in endpoint device 102a may be configured to periodically send (e.g., based on a timer) requests for updates to any rules or policies applicable to telemetry data generated at endpoint device 102a. These requests may be sent to the system back-end (e.g., server 108a of data processing facility 106a). If there has been an update (e.g., if the system administrator has updated any of the policies that are applicable to realm A, to which the requesting endpoint device 102a belongs, then the back-end server (e.g., 108a) may respond to the request by transmitting the requested update, over network 112, back to the requesting endpoint device 102a. In this regard, the back-end server (e.g., 108a) may copy any updated rules or policies from its data store (e.g., 110a) and transmit a copy of the updated rules or policies, over network 112, to endpoint device 102a. Upon receiving the update rules or policies, the endpoint agent 214a of endpoint device 102a may paste the updated data into its agent data store 216a to replace the previous corresponding rules or policies to cause the updated rules or policies to take effect.

As another example, in some implementations, the back-end servers 108a-108k may be configured to periodically push rule or policy updates out to associated endpoint agents 214a-214k in the various endpoint devices 102a-102k. As an example, back-end server 108a may be configured to periodically check (e.g., based on a timer) for updates to any rules or policies applicable to telemetry data generated at one or more of the endpoint devices 102a-102k. If the back-end server 108 determines that any updates are available in its data store 110a, for example, then the back-end server 108a may copy those updated rules or policies and push them out to any associated endpoint devices (e.g., 102a-102e). Then, the associated endpoint devices 102a-102e that receive the updated rules or policies may replace their current corresponding rules and policies in their associated data stores (110a-110e) with the updated rules and policies to cause the updated rules or policies to take effect.

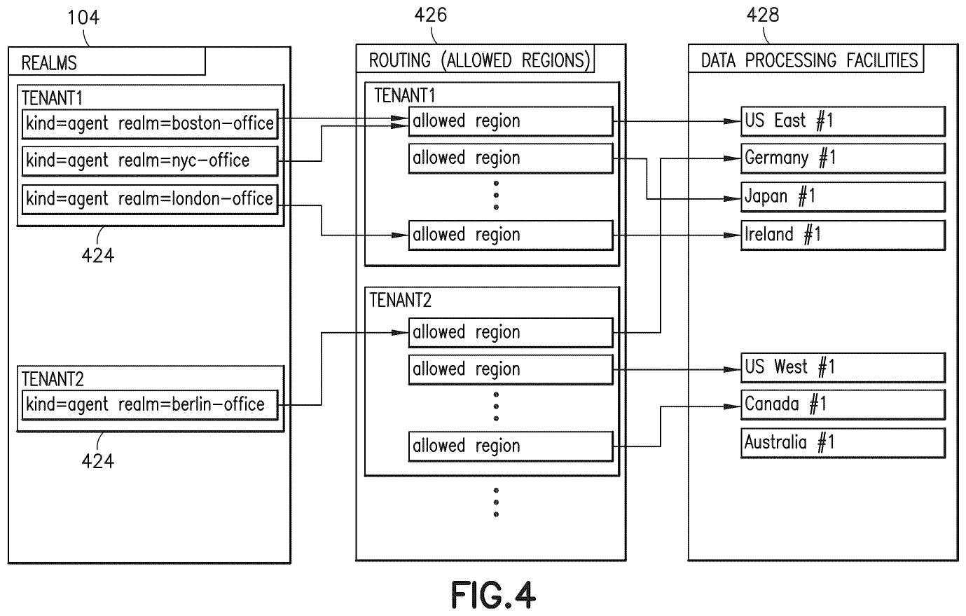

FIG. 4 is a schematic representation showing an exemplary mapping of tenants 424 (e.g., companies or organizations) segmented into realms 104 across a network with allowed regions 426 in the network for routing of data from each of the tenants and available data processing facilities 428 associated with the routing regions 426 and realms 104. In a typical implementation, the mapping represented in FIG. 4 may be stored in a system database (e.g., in one of the system's computer-based memory devices).

More specifically, there are two tenants (tenant 1, tenant 2) represented in the illustrated implementation. Tenant 1 has three separate offices: a Boston office, a New York City office and a London office. Tenant 2 has only one office: in Berlin. There are multiple options for allowed routing regions 428 for each tenant 104. The available data processing facilities 428 include data processing facilities labeled, based on their geographic locations, as follows: US East #1, Germany #1, Japan #1, Ireland #1, US West #1, Canada #1, and Australia #1. Of course, in some implementations, there may be more than only one data processing facility in any particular country or region.

With respect to tenant 1, in the illustrated implementation, the system 200 is configured to allow data from the Boston office and the New York City office to be routed along the same route to the US East #1 data processing facility. Moreover, with respect to tenant 2, in the illustrated implementation, the system 200 is configured to allow data from the London office to be routed to the Ireland #1 data processing facility along a different path than the authorized routing path that the Boston and New York City offices uses.

With respect to tenant 2, in the illustrated implementation, the system 200 is configured to allow data from the Berlin office to be routed along one of the available routing region options to the Germany #1 data processing facility. Of course, under certain applicable regulations, it may be permissible for data from the Berlin office to be processed, for example, in the Ireland #1 data processing facility, which would also be in Europe. However, a company with a Berlin office, as indicated in this example, may prefer for its data to be processed in the same country. Thus, the system can be set up so that the telemetry data collected by endpoint agents in the Berlin office gets routed to the Germany #1 data processing facility rather than the Ireland #1 office.

In a typical implementation, the data represented in FIG. 4 may be stored in the system's computer-based memory (e.g., with some of the data in one or more of the data stores 110a-110k in the data processing facilities and/or in the agent data stores 216a-216k).

Furthermore, some implementations may involve a templating mechanism allowing the realm configuration backend 110c depicted in FIG. 3 to resolve elements of Realm 104, Routing 426 and Data Processing Facilities 428 information and reference it in compiled form Realm 302 FIG. 3 before transmitting it to endpoint agents. Additional information resolved using the templating mechanism may include credentials required to access the designated processing facility.

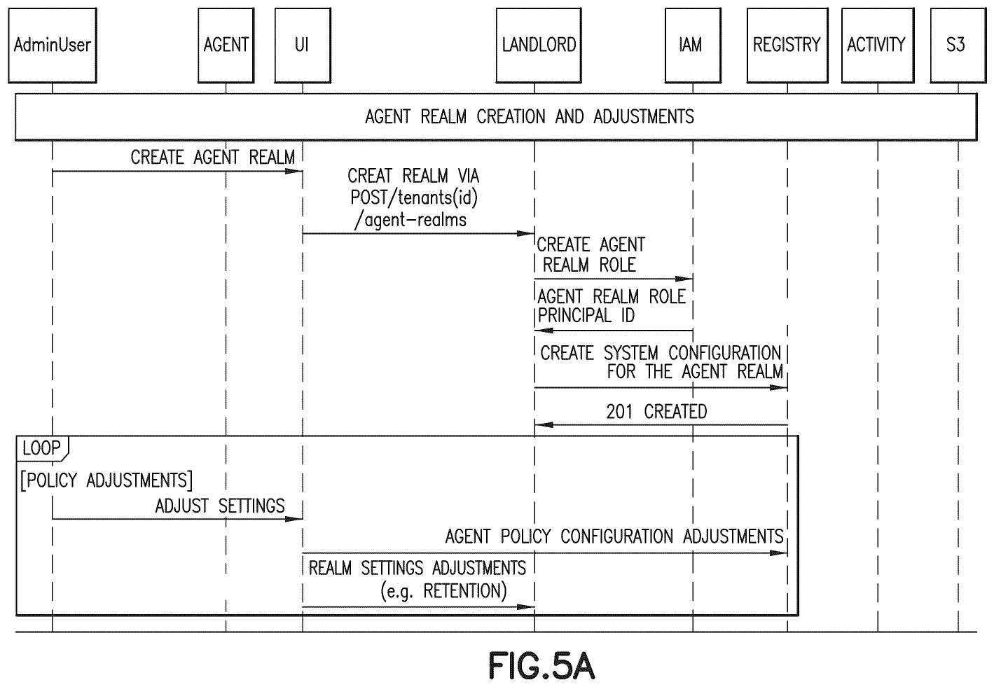

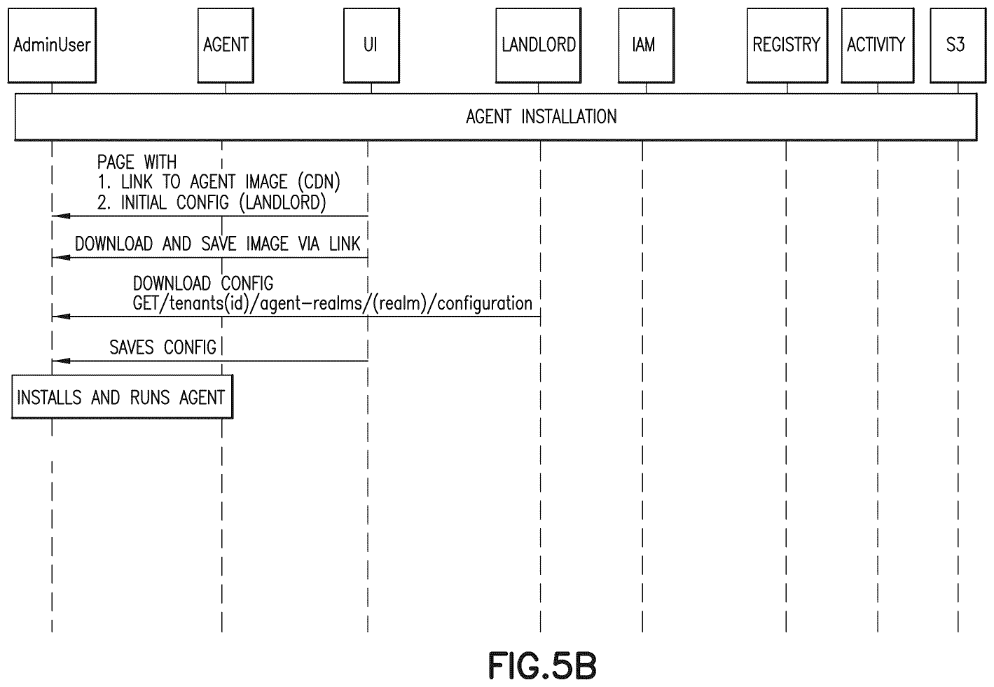

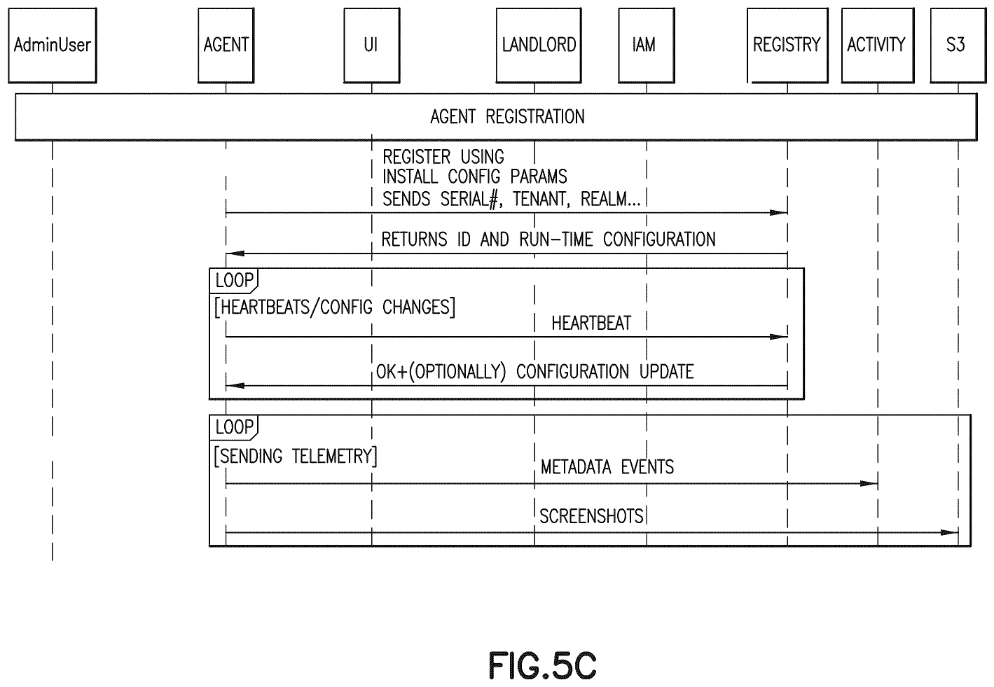

FIG. 5A-5C are swim lane diagrams (or cross functional flow charts) that identifies the roles of various system components, within an exemplary implementation of the network 100 in FIG. 1, to create and/or adjust realm(s) (550), install endpoint agent(s) (552), and/or register the endpoint agent(s) (554).

The components represented in the illustrated swim lane diagrams include a human administrator 556, an endpoint agent 214a, a user interface 560, a landlord service 562, an identity and access management service 564, a registry 566, an activity monitor 568, and an S3 cloud storage service 570. The administrator is a human. Every other component represented in the diagram is a computer component. Of those computer components, in a typical implementation, the endpoint agent 214a and the UI 560 would reside at, and be specific to, a particular one of the endpoint devices (e.g., 102a-102k or 110c). All other components (e.g., the landlord 562, the IAM 564, the registry 566, the activity monitor 568 and the S3 cloud storage service) may reside elsewhere in the system (e.g., in the system back-end at one of the data processing facilities 106a associated with the endpoint device 102a).

The administrator can be virtually any human user with access and operational privileges within the system that enable the operator to create or adjust realms and install endpoint agents. In some implementations, there may be more than one administrator.

The endpoint agent 214a corresponds to one of the endpoint agents 214a-214k in FIG. 2. In a typical implementation, the endpoint agent 214a may be implemented by virtue of a computer-based processor executing software at a corresponding one of the endpoint devices 102a-102k in system 100.

The user interface (UI) includes one or more computer-based hardware components executing software stored in memory to facilitate interactions between a human (e.g., the administrator) and the computer system 100. In a typical implementation, the UI has a visual interface. In some implementations, the visual interface is accompanied by one or more input/output (I/O)) devices such as a keyboard or a mouse or both. In some implementations, the visual interface may be incorporated into and form a part of a graphical user interface. Various other possibilities exist for user interfaces, all of which would include, however, a visual interface.

The landlord 562, in a typical implementation, represents a system service, implemented by virtue of a computer processor executing software, that performs various processing functionalities related to the realm creation, update and deletion, described herein as being attributable to and/or performed by the landlord.

The identity and access management component (IAM) 564 typically includes hardware and associated software and data that provides a framework of policies and technologies for ensuring that the proper people in an enterprise (e.g., company or organization) have the appropriate access to technology resources. In various implementations, the IAM component 564 helps to manage how users gain an identity in the system, the roles and, sometimes, the permissions that identity grants, as well as the protection of that identity and the technologies supporting that protection.

The registry 566 typically is a hierarchical database used to store information that facilitates configuring a system i.e. relaying realm and other related configuration information etc. for one or more users, applications, and/or hardware devices.

Activity 568 typically an activity monitor that captures and/or stores data (e.g., metadata about user activities that occur at the endpoint devices 102a-102k).

S3 570 refers to a cloud storage service, including the supporting hardware and software to support the cloud storage service. One example of an S3 service is offered by Amazon Web Services (AWS) that provides object storage through a web service interface.

Referring now to the swim lane diagram in FIG. 5A, according to the illustrated implementation, an agent realm may be created (550) as follows.

First, a human administrator 556 sends (at 571) a request through the system's user interface 560 to create an agent realm. The realm creation request typically includes the selection of geographical region and policy governing the storage and processing of data as per the compliance guidelines of that particular organization and/or geographical region where the data will reside and/or the geographical region to which the endpoint user belong to. In a typical implementation, the system 200 may include software at the administrator's workstation 113 that prompts or enables the administrator to enter such a request.

Next, in response to receiving the administrator's request, the user interface 560 sends (at 572) a request to the landlord 562 to create a realm. Included in the request typically is information required to setup the realm including items such as default data retention, default routing (facility for data processing and storage) as well as any number of agent configuration settings (for example—maximal memory use allowed by the agent process).

In response to receiving the UI request, the landlord 562 (at 573) sends a request via inter service communication framework to the identity access management (IAM) service 564 to create an agent realm role. The IAM request from landlord 562 to IAM service 564 typically includes the requesting user's id (administrator performing the create realm operation) and the requested operation (e.g., createRealm in this example). The IAM service 564 responds by creating an agent realm role and assigning an agent realm role principal identifier to the agent realm role just created and sends the agent realm role principal identifier back to the landlord 562 (at 574). The IAM service previously performed checks whether user is allowed to perform such operation, this step simply creates an agent realm role in the database. In a typical implementation, all agents operating in the realm will have the agent realm role privileges giving them limited but sufficient ability to access backend services to obtain configuration, transmit telemetry and associated data. The landlord 562 then sends (at 575) a request to the registry 566 to create a system configuration for the agent realm. Typically included in this request is the information governing basic agent behavior in the realm (for example, maximal memory use allowed by the agent process). The registry 566 responds by creating the system configuration for the agent realm and then (at 576) sends a confirmation (201 CREATED) back to the landlord 562. The system configuration includes the information such as principles governing data capture, location of remote storage and API endpoint etc. More specifically, in the illustrated example, the confirmation (201 CREATED) sent back to the landlord 562 (at 577) indicates that the request to create a system configuration for the agent realm has been fulfilled and resulted in a new resource (e.g., the system configuration for the agent realm) being created. In a typical implementation, the confirmation may include a uniform resource identifier, for example, that can be used to reference the newly created resource.

Once created, the information relating to the system configuration created by the registry 566 in response to the request at 575 may be stored, for example, in memory 110a in the data processing facility 106a that corresponds to any endpoint devices that may end up being a member of the associated realm.

The box, labeled “Loop” at the bottom of the diagram in FIG. 5A represents steps involved in one implementation of policy adjustments being made in an existing realm. The policy adjustment process represented in the “Loop” portion of the diagram could be used to modify rules of an existing policy that is applicable to the realm or to add new entirely rules or policies to apply to an existing realm.

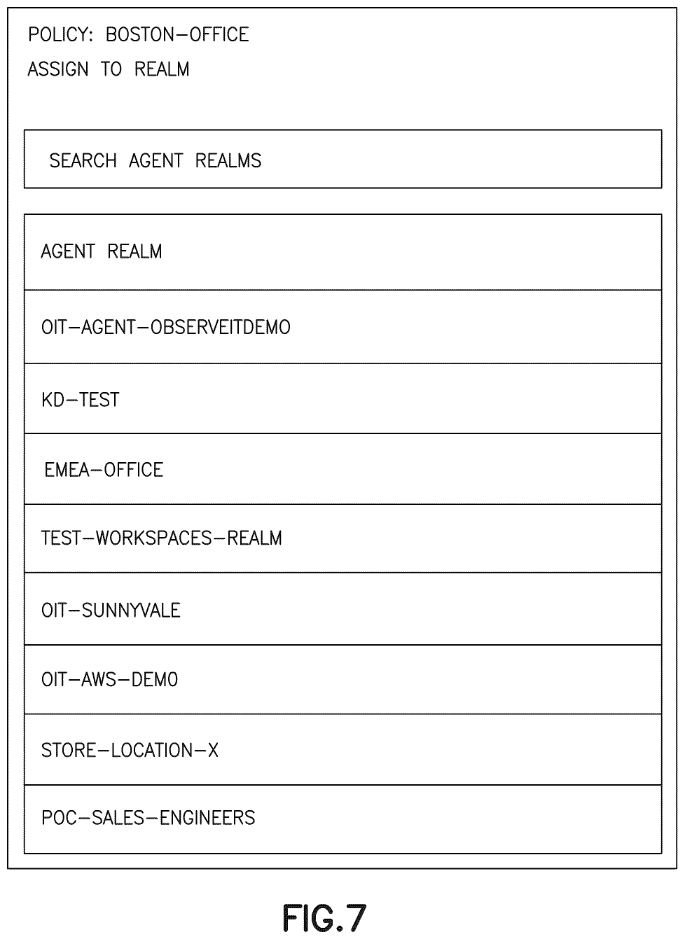

According to the illustrated implementation, the administrator 556 (at 577) enters a command “Attach Policy” at the user interface UI 560 to adjust the applicable policies for a realm. In a typical implementation, the system 200 includes software that prompts or enables the administrator 556 from his or her workstation 113 to enter adjustments to the realm policy settings in this manner. FIG. 7 shows an example of a screenshot that might give the administrator access to make these sorts of changes.

For example, the system may include software that enables the administrator 556 to view and/or edit/modify any policies and/or underlying rules that apply to a particular realm. This editing/modifying functionality may, of course, include adding entirely new rules or policies to any existing rules or policies that already apply to the associated realm. In this regard, the software may enable the administrator 556 to view some or perhaps all of the rules and policies that apply to an associated realm. In some implementations, until the administrator adds new rules or policies to a realm, the realm may be subject only to a base number of rules or policies that may simply specify (consistent with applicable legal frameworks and/or basic enterprise preferences) only one (or perhaps more) permitted routing path (see, e.g., 426, see FIG. 4) from any endpoint devices in the realm and a permitted data processing facility 428 (see, e.g., 428 in FIG. 4) for data leaving any endpoint devices in the realm.

In response to receiving the administrator's command (at 577), the user interface (UI) 560 sends (at 578) a request to the registry 566 for an agent policy configuration adjustment consistent with the administrator's command (at 577). Examples of policy adjustment can include adjustments to a machine-readable form of data capture rules as described above. In response to receiving the request from the UI 560, the registry 566 makes the requested updates. The resulting new set of rules and policies applicable to the realm may be stored (e.g., in memory 110a) at the data processing facility 106a assigned to the associated realm. These updates subsequently get transferred to (and take effect at) the endpoint agents of the endpoint devices of the associated realm, in response to requests made by the endpoint agents.

In addition to sending a request to the registry for an agent policy configuration adjustment (at 578), the UI 560 also sends (at 579) a realm setting adjustment (e.g., retention) message to the landlord. Typically, adjustments to settings such as retention are encoded in machine readable form (e.g. JSON property with a value of new retention in seconds).

This process (represented by 577, 578 and 579) can loop over and over anytime there is a request by the administrator to change the rules or policies of the associated realm.

In a typical implementation, once a realm has been created, an agent may be installed. FIG. 5B is a swim land diagram that shows some of the steps involved in one implementation of an agent installation process (552).

According to the illustrated diagram, the UI 560 presents (at 580) to the administrator 556 (e.g., at the endpoint device where the agent is being installed) a page that includes a link to an agent installer image (CDN, content delivery network) and initial configuration information (landlord). Typically, the initial configuration information includes reference (URL) of the registry in the data processing facility the agent requires to register and obtain further configuration. Along with the reference a cryptographic token with time limited validity is also provided so that the backend registry service can authenticate and authorize the incoming call and validate that the agent is allowed to be attached to the realm.

At 581 in the illustrated process, the administrator 556 selects the link, which causes the endpoint device to download the associated agent image (CDN) to be saved at the endpoint device. In a typical implementation, the downloaded agent image (CDN) may be saved (at 583), for example, to the agent data store of the associated endpoint device.

As represented at 582 in the illustrated process, the administrator 556 also initiates a download (e.g., by the endpoint device) of a configuration file for the agent installation. In general terms, a configuration file is used to configure the parameters and initial settings for a computer program. In the illustrated implementation, once downloaded to the endpoint device, the configuration file may be used configure the parameters and initial settings for the endpoint agent to be installed at the endpoint device. In some implementations, the configuration file may include information on rules and policies applicable to the realm as well as data identifying permitted data routes from endpoint devices in the realm and permitted data processing facilities for the realm. In the illustrated implementation, the configuration file is obtained via a get request—GET/tenants[id]/agents-realms/[realm]/configurations. In general terms, get requests are used to request data from a specified resource. In the illustrated implementation, the request is made to the landlord.

In response to the Get request, the configuration information is downloaded from the landlord 562 for viewing by the administrator 556 on the UI 560. Then, the administrator 556, at the user interface, saves the downloaded configuration information at the endpoint device (e.g., in computer memory at the device).

Next, (at 584), the system administrator 556 installs and runs the agent. In a typical implementation, the system administrator 556 may do this by clicking on a link at the UI 560 of the endpoint device 102a. This causes the endpoint agent 214a to be installed and run at the endpoint device, thus making effective the endpoint agent 214a on the endpoint device 102a.

In a typical implementation, once the realm has been created, and the endpoint agent 214a has been installed, the endpoint agent 214a can be registered with the realm. FIG. 5C is a swim land diagram that shows some of the steps involved in one implementation of an endpoint agent installation process (554).

According to the illustrated diagram, the agent 214a (at 585) sends a registration request to the registry 566. The registration request in the illustrated implementation uses install config parameters to identify, authenticate and provide accurate information to the registry backend service. Typically, the information included and provided in the installation configuration file is a cryptographically signed component identification including tenant, realm, component type (e.g. agent).

In response to the registration request, the registry 566 registers the endpoint agent 214a with the tenant, realm and component type identified in the request. In this regard, the registry 566 may store information, along the lines represented in FIG. 4, for example, based, at least in part, on information included in the registration request.

Then, upon successful registration, the registry 566 (at 586) returns a registration identifier and run-time configuration data to the endpoint agent 214a. Run-time information usually includes additional service references (URLs) and time bound credentials enabling the agent to transmit information. Finally, and importantly in a typical implementation, the registry transmits the compiled realm policy and routing information that the agent can used to determine what data to collect, when and where to transmit it as described above.

When the endpoint agent 214a receives the registration identifier and run-time configuration data it stores those in its endpoint agent data store for use, for example, during run time operations.

At this point in the process of FIGS. 5A-5C, the realm has been created and the endpoint agent 214a has been installed at the endpoint device 102a and registered within the realm.

Next, according to the illustrated implementation, the system enters a sort of stand-by mode (or a heartbeats/configuration changes loop), whereby, the endpoint agent 214a periodically (at 588) sends heartbeats to the registry and the registry responds with a confirmation receipt (OK) and optionally provides any configuration updates that might be relevant to the endpoint agent 214a. In a typical implementation, a heartbeat is a periodic signal generated by hardware or software to indicate normal operation or to synchronize other parts of a computer system. Usually a heartbeat is sent between machines/system components at regular intervals (e.g., on the order of seconds): a heartbeat message. If the intended recipient of the heartbeat messages (here, the registry 566) does not receive a heartbeat for a time—usually a few heartbeat intervals—the endpoint agent 214a may be assumed to have failed.

Next, according to the illustrated implementation, the system reacts to a user activity at the endpoint device 102a. More specifically, the user activity at the endpoint device 102a causes the endpoint agent 214a to collect and transmit (at 592) metadata about the event (i.e., the user activity) to the activity monitor 568. The activity monitor is typically used to detect and investigate security and compliance violations. Moreover, (at 594) the endpoint agent 214a collects and transmits one or more screenshots (screengrabs) of the triggering user activity to the S3 cloud storage service 570. These screenshots (screengrabs) are stored by the S3 cloud storage service. In a typical implementation, the metadata that is transmitted to the activity monitor 568 is processed to determine whether the user activity represented by the metadata might pose a threat to the enterprise. If so, the system generates and sends an alert to the system administrator. The threat alert might be accompanied by one or more of the screenshots that were stored in the S3 cloud storage service and associated with the metadata from the triggering user activity.

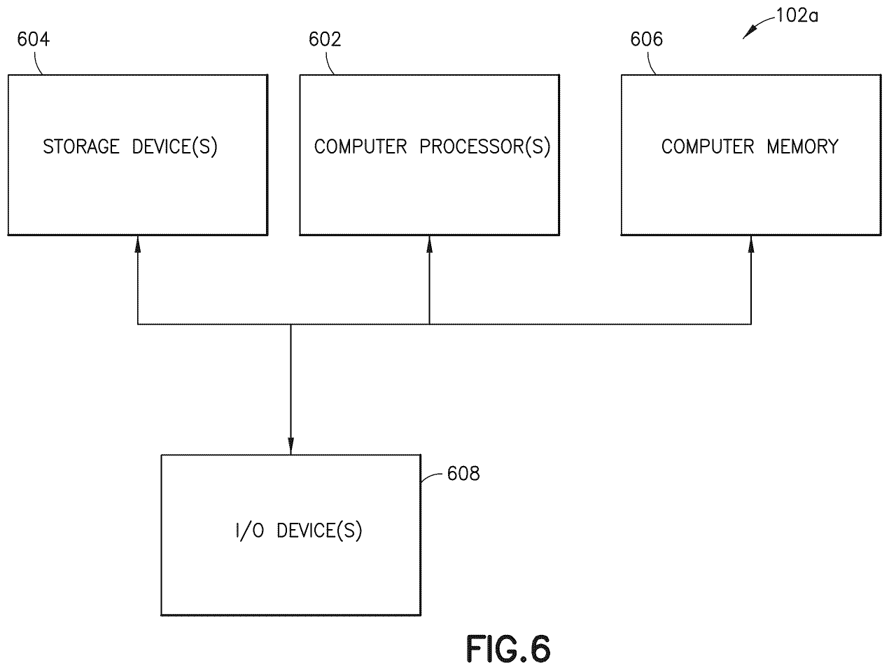

FIG. 6 is a schematic representation of an exemplary endpoint device (e.g., 102a in system 100).

The illustrated endpoint device 102a in FIG. 6 has a computer-based processor 602, a computer-based storage device 604, and a computer-based memory 606. The computer-based memory 606 hosts the operating system 218a and software that, when executed by the processor 602, causes the processor 602 to perform, support and/or facilitate functionalities disclosed herein that are attributable to the processor 602 and/or to the endpoint device 102a or its agent 214a. More specifically, in a typical implementation, the computer-based memory 606 stores instructions that, when executed by the processor 602, causes the processor 602 to perform the functionalities associated with the endpoint device and its agent that are disclosed herein as well as any related and/or supporting functionalities. The endpoint device 102a has one or more input/output (I/O) devices 608 (e.g., to interact with and receive input from the external environment, e.g., a user or administrator).

A number of embodiments of the invention have been described. Nevertheless, it will be understood that various modifications may be made without departing from the spirit and scope of the invention.

This application refers to the concepts of realms. In a typical implementation, a realm may be defined by the data that defines its parameters (e.g., its permissible destination data processing facilities and/or routes through the network) and/or its members (e.g., the endpoint agents that follow the parameters of the realm): the realm definition, aspects of which may be stored, for example, in agent data stores and/or elsewhere in the system. Realms may be established to loosely correspond to physical facilities (e.g. corporate offices—“London”, “Berlin”, “Chicago Data Center”, etc.) or physically bounded organizational entities (e.g., “Roaming West Coast Sales”), particularly where the same basic data protection and privacy restrictions might apply across a particular physical facility or organizational entity. The systems and techniques disclosed herein enables grouping of endpoints under (or as part of) “realms” in order to facilitate observing and complying with local regulations for all locales and countries that are supported (US West and East Coast, Mainland EU, Ireland, Australia, etc.). For that reason, realms typically should not be defined in a way that one realm straddles multiple jurisdictions that do not share common privacy and data sovereignty regulations. One example of a bad realm definition title might be “US and EU Manufacturing Facilities,” because the GDPR applies directly in the EU but not in the US.

Examples of regional regulations include the EU's General Data Protection Regulation (GDPR), California Consumer Privacy Act (CCPA), etc. Those regulations may include a requirement that all data to be processed within the local jurisdiction in which it was gathered, or that certain personally identifiable information (PII) has to be omitted or anonymized. Other regional regulations may apply to certain circumstances. The systems and techniques disclosed herein typically facilitate satisfying these requirements. Moreover, in some instances, a company may want to specify which information they gather from the endpoints regardless of location. Rules defining this gathering of information may be combined into policies, which may (or may not be) applied to certain realms. An example of a data gathering rule of this type might be: “all activity of users belonging to Data Base Administrator group running SQL Server Management Studio”. Another example would be “all activity involving downloading a file from an internal application, copying, renaming it and uploading it to a personal web storage (google driver, dropbox) or social media websites”.

The endpoint device 102a-102k can be any a computer-based hardware device, with underlying software, that is able to communicate over the computer network 100 with other devices. Specific examples of endpoint devices 102 include desktop computers, laptop computers, smart phones and other mobile devices, computer tablets, and any other computer hardware device that is connected to able to communicate data over a communication medium (e.g., the Internet).

Additionally, applicable rules and/or policies may apply based, in part, in a user's profile (e.g., his or her job or role within the enterprise), location, or other attributes (e.g., what country or sovereignty they are registered in the enterprise directory as an employee).

In some implementations, rule and/or policy updates may be put into effect by the system, at least with respect to a particular realm, when the endpoint devices in that realm have received the updates. Update requests from the endpoint agents may be generated automatically and may be on a particular time schedule (e.g., every ten minutes or on some other regular or irregular frequency). In some implementations, the updates are pushed out to associated endpoint agents automatically when, and in response to, an update happens. In some implementations, the computer network is configured to enable a system administrator, for example, to initiate a transfer of any new rules information to the associated endpoint agents in the computer network anytime (e.g., by selecting an update button or performing some other take or sequence of tasks at a computer-based user interface).

Collecting endpoint telemetry data can be triggered by any one of a variety of potential user activities (not background system functionalities) including, for example: launching of an application (with the resulting telemetry data including application process details—name, path, process ID, etc.), copying, renaming, deleting a file (with the resulting telemetry data including file attributes—name, path, ownership, etc.), uploading/copying a file to a website, USB device or a network drive, etc. The telemetry data typically has a “context” reference that identifies, for example, one or more of the endpoint devices, user, agent, remote access details, etc. Other activity types that may trigger the collection of telemetry data include, for example, a physical security card being swiped in/out (the resulting telemetry data may include facility, room and other relevant information), or a human resources related events, such as change of role within an organization or a 15-day notice event.

In a typical implementation, the endpoint agents may be updated regularly or, in some instances, constantly with a compiled set of rules instructing them on which data to gather and how to route that data in adherence with data sovereignty restrictions, such as the GDPR for example, or the like, and/or customer preferences and within realms.

In a typical implementation, an end point realm may include: 1) one or more end points that are subject to the same collection of telemetry data gathering and/or routing rules, 2) one or more data processing facilities to which the end point(s) in the end point realm can transmit the telemetry data in accordance with separate (optional) the telemetry data gathering and/or routing rules, and 3) one or more separate (optional) policies (stored in computer-based memory) that include the telemetry data gathering and/or routing rules. Endpoint realms, therefore, may provide endpoints with their data processing facility in addition to relevant recording policies.

Endpoint agents may adjust their feeds and route them to specific regional data processing facilities as described in compiled rules and routing configurations that may be updated and pushed to the agents. In addition, endpoints typically maintain a level of independence allowing them to not only intelligently gather and route traffic, but also delay sending information in case their regional data processing facility is unreachable.

Telemetry refers to the collection of measurements or other data at remote points and their automatic transmission to receiving equipment for monitoring. In various implementations, telemetry may include monitoring, collecting, and/or analyzing data from a computer and/or system to track user activity in a networked device, for example, to determine inappropriate or potentially harmful access to and/or use of system resources. Telemetry may involve the collection of measurements or other data at remote points (“endpoints”) and their automatic transmission to receiving equipment for monitoring. The telemetry may be collected by an agent installed at the endpoint working in conjunction with the operating system of the endpoint computer/system to monitor user activity such as data usage (bandwidth), file/resource access, internet activity, keystrokes, mouse/keypad movements and clicks, and/or use of external devices (such as USB drives), among others. Telemetry data refers to data (or metadata) collected via or for telemetry.

In various implementations, the telemetry data related to a user activity that the computer network collects in response to a triggering user activity (e.g., a mouse click, etc.) can include, for example, file management data for an associated file and/or session information associated with the user session in which the activity took place and/or screen grabs.

In a typical implementation, each time a triggering user activity occurs at one of the endpoint devices 102a-102k, the system analyzes at least some of the metadata associated with the user activity, including associated file management data and/or session information, to determine whether the associated user activity might pose a threat (e.g., an insider threat) to data security or privacy. There are a variety of ways that this analysis and determination might be performed. Some details of this kind of approach are disclosed in US Patent Application Publication No. 2020/0193019, entitled Managing Data Exfiltration Risk, which is incorporated by reference herein in its entirety and in particular with respect to its description of techniques and systems for analyzing and determining whether data related to a particular user activity might indicate an insider threat, such as exfiltration risk.

In a typical implementation, the applicable policies form part of the realm definitions. In some such implementations, when the realms are formed, there may be default policies that automatically become part of the associated realms. In some such implementations, other policies may be added later and used to supplement the associated realm definitions. In some implementations, a new realm-specific policy may be written prior to creating the associated realm. In that instance, when the realm is created, the associated policy is applied as part of the realm definition.

Initially, when the realm is initially created, any applicable policies may be stored as part of the realm. When an agent communicates with the back end (e.g., 106a, 106b) based on realm credentials, the back end makes a decision as to which realm the agent is part of and gathers all the policy information and sends it to the agent. From time to time, the agent may communicate with the back end and if there is a policy change, it gets a new copy.

The techniques and systems disclosed herein may be integrated into and used with the ObserveIT Insider Threat Management (ITM) solution, available from Proofpoint. Inc. However, the techniques and systems disclosed herein are not limited to that solution.

Various aspects of the subject matter disclosed herein can be implemented in digital electronic circuitry, or in computer-based software, firmware, or hardware, including the structures disclosed in this specification and/or their structural equivalents, and/or in combinations thereof. In some embodiments, the subject matter disclosed herein can be implemented in one or more computer programs, that is, one or more modules of computer program instructions, encoded on computer storage medium for execution by, or to control the operation of, one or more data processing apparatuses (e.g., processors). Alternatively, or additionally, the program instructions can be encoded on an artificially generated propagated signal, for example, a machine-generated electrical, optical, or electromagnetic signal that is generated to encode information for transmission to suitable receiver apparatus for execution by a data processing apparatus. A computer storage medium can be, or can be included within, a computer-readable storage device, a computer-readable storage substrate, a random or serial access memory array or device, or a combination thereof. While a computer storage medium should not be considered to be solely a propagated signal, a computer storage medium may be a source or destination of computer program instructions encoded in an artificially generated propagated signal. The computer storage medium can also be, or be included in, one or more separate physical components or media, for example, multiple CDs, computer disks, and/or other storage devices.

Certain operations described in this specification can be implemented as operations performed by a data processing apparatus (e.g., a processor/specially-programmed processor) on data stored on one or more computer-readable storage devices or received from other sources. The term “processor” (or the like) encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, for example, code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

Any processor(s) described herein can be implemented as one or more than one processor, and any processes described herein can be performed by one or more than one processor. If implemented as more than one processor, the processors can be located in one facility or distributed across multiple locations. Likewise, any memory described herein can be implemented as one or more than one memory device. If implemented as more than one memory device, the memory devices can be located in one facility or distributed across multiple facilities or locations.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations may be described herein as occurring in a particular order or manner, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

In various implementations, a computer-readable medium computer-readable storage medium may include instructions that, when executed by a computer-based processor, cause that processor to perform or facilitate one or more (or all) of the processing and/or other functionalities disclosed herein. The phrase computer-readable medium or computer-readable storage medium is intended to include at least all mediums that are eligible for patent protection, including, for example, non-transitory storage, and, in some instances, to specifically exclude all mediums that are non-statutory in nature to the extent that the exclusion is necessary for a claim that includes the computer-readable (storage) medium to be valid. Some or all of these computer-readable storage media can be non-transitory.

Other implementations are within the scope of the claims.

What is claimed is:

1. A method comprising:
creating a realm in a computer-based network, wherein the realm includes and is defined by a realm definition, stored in computer-based memory, that at least identifies one or more data processing facilities in the network as permissible destinations, under applicable data protection or privacy restrictions, for telemetry data transmitted by endpoint agents within the realm;
installing an endpoint agent in an endpoint device; and
registering the endpoint agent with the realm.

2. The method of claim 1, wherein the realm definition further identifies one or more permissible routes through the network, under applicable data protection or privacy restrictions, for the telemetry data transmitted by endpoint agents in the realm.

3. The method of claim 1, wherein the endpoint agent in the endpoint device is configured to:
collect telemetry data relating to user activity at its associated endpoint device and
transmit the collected telemetry data to one of the permissible destination data processing facilities identified in the realm definition.

4. The method of claim 3, wherein the endpoint agent in the endpoint device is further configured to restrict its transmission of the collected telemetry data to a permissible route through the network.

5. The method of claim 3, wherein the data processing facility is configured to:
analyze the telemetry data to identify potential insider threats posed by the user activity associated with the telemetry data; and
create an alert if any such insider threat is identified.

6. The method of claim 1, further comprising:
creating other realms in the computer network;
installing an endpoint agent in each respective one of a plurality of other endpoint devices; and
registering all of the endpoint agent in the other endpoint devices with a corresponding one of the realms.

7. The method of claim 6, wherein each realm has a different realm definition than the other realms.

8. The method of claim 1, further comprising updating realm definitions periodically.

9. The method of claim 1, wherein computer-based network comprises a plurality of user endpoint devices geographically distributed relative to one another such that activities on at least one of the plurality of endpoint devices is subject to a different set of data protection or privacy restrictions than activities on another one of the plurality of endpoint devices.

10. The method of claim 9, wherein endpoint devices that have endpoint agents registered with the realm form a subset of the endpoint devices in the computer-based network.

11. The method of claim 10 wherein the computer-based network comprises:
a plurality of data processing facilities communicatively coupled to the user endpoint devices in the computer-based network, wherein the data processing facilities are in different geographical regions or sovereignties.

12. The method of claim 11, further comprising:
collecting, with the endpoint agent installed in the endpoint device, telemetry data relating to user activity at the endpoint device; and
transmitting the collected telemetry data from the endpoint agent to a selected one of the data processing facilities in compliance with the data protection and privacy restrictions that apply to the endpoint agent's endpoint device.

13. The method of claim 12, further comprising:
logically segmenting the computer-based network into a plurality of realms, wherein the plurality of realms includes the created realm;
installing an endpoint agent into each respective one of the endpoint devices in the computer-based network; and
registering each respective endpoint agent to a particular one of the plurality of realms.

14. The method of claim 13, further comprising:
providing an agent data store at each respective one of the endpoint devices, wherein each of the agent data stores contains data that identifies:
one or more of the data processing facilities as being permissible destinations, under applicable data protection or privacy restrictions, for the telemetry data transmitted by the endpoint agent; and/or
one or more routes through the network as being permissible routes, under applicable data protection or privacy restrictions, for the telemetry data transmitted by the endpoint agent to one of the permissible destination data processing facilities.

15. The computer network of claim 14, wherein the endpoint agent in each endpoint device is configured to transmit the telemetry data to one of the identified permissible destination data processing facilities via one of the identified permissible routes though the computer-based network.

16. The computer network of claim 15, wherein the endpoint agents are configured to periodically receive updates regarding the permissible destination data processing facilities and/or permissible routes through the computer-based network from a remote data store.
